(19) United States
(12) Patent Application Publication
(10) Pub. No.: US 2024/0400460 A1
(43) Pub. Date: Dec. 5, 2024

(54) SINTERED ZIRCONIA BEADS

(71) Applicant: SAINT-GOBAIN CENTRE DE RECHERCHES ET D'ETUDES EUROPEEN, COURBEVOIE (FR)

(72) Inventors: Anne-Laure BEAUDONNET, ROBION (FR); Nassira BENAMEUR, JONQUIERES (FR)

(21) Appl. No.: 18/695,647

(22) PCT Filed: Sep. 26, 2022
(86) PCT No.: PCT/EP2022/076706

§ 371 Date: Mar. 26, 2024

(30) Foreign Application Priority Data
Sep. 28, 2021 (FR) 2110208

(51) Int. Cl. C04B 35/488; C04B 35/626

(52) U.S. Cl. CPC C04B 35/488; C04B 35/62655; C04B 2235/3225; C04B 2235/3229; C04B 2235/3246

(57) ABSTRACT

A sintered bead has a chemical composition, as mass percentages on the basis of the oxides of ZrO₂+HfO₂+Y₂O₃+CeO₂: balance to 100%; 0%≤Al₂O₃≤1.5%; CaO≤2%; and oxides other than ZrO₂, HfO₂, Y₂O₃, CeO₂, Al₂O₃ and CaO: ≤5%. The contents of Y₂O₃ and CeO₂, as molar percentages on the basis of the sum of ZrO₂, HfO₂, Y₂O₃ and CeO₂, are such that 1.3%≤Y₂O₃≤2.5%, in particular 1.3%≤Y₂O₃<1.8%, and 0.1%≤CeO₂≤1.7%, in particular 0.5%≤CeO₂≤1.7%, in particular 0.9%<CeO₂≤1.7%. The chemical composition has the following crystalline phases, as mass percentages on the basis of the crystalline phases and for a total of 100%: stabilized zirconia: balance to 100%; monoclinic zirconia: ≤15%; and crystalline phases other than stabilized zirconia and monoclinic zirconia: <7%, with the proviso that: Y₂O₃<1.8% with the proviso that 0.5%≤CeO₂, and/or 0.9%<CeO₂≤1.7%, and/or 10%<monoclinic zirconia≤15%.

### TECHNICAL FIELD

The present invention relates to sintered zirconia beads, to a process for manufacturing these beads, and to the use of these beads as grinding media or as wet dispersion agents or for surface treatment.

### PRIOR ART

The paint, ink, dye, magnetic lacquer and agrochemicals industries use beads for the dispersion and homogenization of liquid and solid constituents.

The mineral industry employs beads for the fine grinding of materials that may have been pre-ground dry via conventional processes, notably for the fine grinding of calcium carbonate, titanium oxide, gypsum, kaolin, and iron ore.

In the field of microgrinding, rounded-particle sand, glass beads, metal beads and ceramic beads are known.
Rounded-particle sand, for instance Ottawa sand, is a natural and cheap product, but is unsuitable for modern, pressurized, high-speed grinders. The reason for this is that sand is weak, of low density, variable in quality and abrasive to the equipment.
Glass beads, which are widely used, have better strength and lower abrasiveness and are available in a wider range of diameters.
Metal beads, notably steel beads, have low inertness with respect to the products being processed, notably leading to pollution of mineral fillers and graying of paints, and an excessively high density, requiring special grinders. They notably involve high energy consumption, significant heating and high mechanical stress on the equipment.
Ceramic beads have better strength than glass beads, a higher density and excellent chemical inertness.

The beads are conventionally between 0.005 and 10 mm in size.

The following may be distinguished:
fused ceramic beads, generally obtained by melting ceramic components, forming spherical drops from the molten material, and then solidifying said drops, and
sintered ceramic beads, generally obtained by cold-forming a ceramic powder, followed by consolidating it by firing at high temperature.

Unlike sintered beads, fused beads usually include a very abundant intergranular vitreous phase filling a network of crystalline grains. The problems encountered with sintered beads and fused beads in their respective applications, and the technical solutions adopted for solving them, are thus generally different. Moreover, owing to the significant differences between manufacturing processes, a composition developed for manufacturing a fused bead is, in principle, unsuitable for manufacturing a sintered bead, and vice versa.

There is an ongoing need for sintered zirconia beads with improved wear resistance, in particular for grinding applications.

One aim of the invention is to address this need, at least partially.

### DISCLOSURE OF THE INVENTION

### Summary of the Invention

Claimed by the Applicant in the international patent application filed Apr. 2, 2021 under

No. PCT/EP2021/058816 is a sintered bead, having:
the following chemical composition, as mass percentages on the basis of the oxides:
   ZrO₂+HfO₂+Y₂O₃+CeO₂: balance to 100%;
   0%≤Al₂O₃≤1.5%;
   CaO≤2%;
   oxides other than ZrO₂, HfO₂, Y₂O₃, CeO₂, Al₂O₃ and CaO: ≤5%;
the contents of Y₂O₃ and CeO₂, as molar percentages on the basis of the sum of ZrO₂, HfO₂, Y₂O₃ and CeO₂, being such that 1.8%≤ Y₂O₃≤2.5% and 0.1%≤ CeO₂≤0.9%, and
the following crystalline phases, as mass percentages on the basis of the crystalline phases and for a total of 100%:
   stabilized zirconia: remainder to 100%;
   monoclinic zirconia: ≤10%;
   crystalline phases other than stabilized zirconia and monoclinic zirconia: <7%.

The reason is that the inventors have found that beads of these kinds exhibit improved wear resistance, in particular under hydrothermal conditions. Complementary, in-depth research, however, has led to a finding that these beads also have excellent wear resistance if:
1.3%≤Y₂O₃≤1.8%, with the proviso that 0.5%≤CeO₂≤1.8%, and/or
0.9%<CeO₂≤1.8%, and/or
10%<monoclinic zirconia≤15%.

The invention therefore relates to a sintered bead having:
the following chemical composition, as mass percentages on the basis of the oxides:
   ZrO₂+HfO₂+Y₂O₃+CeO₂: balance to 100%;
   0%≤Al₂O₃≤1.5%;
   CaO≤2%;
   oxides other than ZrO₂, HfO₂, Y₂O₃, CeO₂, Al₂O₃ and CaO: ≤5%;
the contents of Y₂O₃ and CeO₂, as molar percentages on the basis of the sum of ZrO₂, HfO₂, Y₂O₃ and CeO₂, being such that
1.3%≤ Y₂O₃≤2.5%, in particular 1.3%≤ Y₂O₃<1.8%, and
0.1%≤ CeO₂≤1.8%, in particular 0.5%≤ CeO₂≤1.8%, in particular 0.9%<CeO₂≤1.8%, preferably CeO₂≤1.7%, and
the following crystalline phases, as mass percentages on the basis of the crystalline phases and for a total of 100%:
   stabilized zirconia: balance to 100%;
   monoclinic zirconia: ≤15%;
   crystalline phases other than stabilized zirconia and monoclinic zirconia: <7%, with the proviso that:
Y₂O₃<1.8% with the proviso that 0.5%≤ CeO₂, preferably 0.8%≤ CeO₂, and/or
0.9%<CeO₂≤1.8%, preferably CeO₂≤1.7%, and/or
10%<monoclinic zirconia≤15%.

As will be seen in greater detail in the rest of the description, unexpectedly, the inventors have found that in the complementary compositional range thus defined, but also in the range defined in PCT/EP2021/058816, but with a content of monoclinic zirconia of greater than 10% and less than or equal to 15%, a sintered zirconia bead may be obtained which exhibits excellent strength during grinding.

The sintered zirconia beads according to the invention are thus particularly well suited to wet dispersion and microgrinding applications.

In a first preferred main embodiment, the invention relates to a sintered bead having:
the following chemical composition, as mass percentages on the basis of the oxides:
   ZrO₂+HfO₂+Y₂O₃+CeO₂: balance to 100%;
   0%≤Al₂O₃≤1.5%;
   CaO≤2%;
   oxides other than ZrO₂, HfO₂, Y₂O₃, CeO₂, Al₂O₃ and CaO: ≤5%;
the contents of Y₂O₃ and CeO₂, as molar percentages on the basis of the sum of ZrO₂, HfO₂, Y₂O₃ and CeO₂, being such that
1.3%≤ Y₂O₃<1.8% and 0.5%≤ CeO₂≤1.8%, preferably 0.5%≤ CeO₂≤1.7%, preferably
0.8%≤ CeO₂≤1.7%, and
the following crystalline phases, as mass percentages on the basis of the crystalline phases and for a total of 100%:
   stabilized zirconia: balance to 100%;
   monoclinic zirconia: ≤15%, preferably ≤10%;
   crystalline phases other than stabilized zirconia and monoclinic zirconia: <7%.

In a second main embodiment, the invention relates to a sintered bead having:
the following chemical composition, as mass percentages on the basis of the oxides:
   ZrO₂+HfO₂+Y₂O₃+CeO₂: balance to 100%;
   0%≤Al₂O₃≤1.5%;
   CaO≤2%;
   oxides other than ZrO₂, HfO₂, Y₂O₃, CeO₂, Al₂O₃ and CaO: ≤5%;
the contents of Y₂O₃ and CeO₂, as molar percentages on the basis of the sum of ZrO₂, HfO₂, Y₂O₃ and CeO₂, being such that
1.3%≤Y₂O₃≤2.5%, and
0.9%<CeO₂≤1.8%, preferably 0.9%<CeO₂≤1.7%, and
the following crystalline phases, as mass percentages on the basis of the crystalline phases and for a total of 100%:
   stabilized zirconia: balance to 100%;
   monoclinic zirconia: ≤15%, preferably ≤10%;
   crystalline phases other than stabilized zirconia and monoclinic zirconia: <7%.

FIG. 1 shows the compositional range 10 of international patent application No. PCT/EP2021/058816 and the complementary compositional range 12 according to the first and second main embodiments of the present invention.

In a third main embodiment, the invention relates to a sintered bead having:
the following chemical composition, as mass percentages on the basis of the oxides:
   ZrO₂+HfO₂+Y₂O₃+CeO₂: balance to 100%;
   0%≤Al₂O₃≤1.5%;
   CaO≤2%;
   oxides other than ZrO₂, HfO₂, Y₂O₃, CeO₂, Al₂O₃ and CaO: ≤5%;
the contents of Y₂O₃ and CeO₂, as molar percentages on the basis of the sum of ZrO₂, HfO₂, Y₂O₃ and CeO₂, being such that
1.3%≤Y₂O₃≤2.5%, and
0.1%<CeO₂: 1.8%, and
with the proviso that if Y₂O₃<1.8%, then 0.5%≤ CeO₂,
and
the following crystalline phases, as mass percentages on the basis of the crystalline phases and for a total of 100%:
   stabilized zirconia: balance to 100%;
   10%<monoclinic zirconia≤15%;
   crystalline phases other than stabilized zirconia and monoclinic zirconia: <7%.

Insofar as an optional feature of international patent application No. PCT/EP2021/058816 is technically compatible with a main embodiment, that feature is optionally applicable to this embodiment.

Irrespective of the main embodiment, a sintered zirconia bead according to the invention may also have one or more of the following optional features, provided these features are compatible with the main embodiment in question:
the sintered bead consists of oxides for more than 99% of its mass;
preferably, the content of Y₂O₃ is less than 2.4%, preferably less than 2.2%, preferably less than 2.0%, preferably less than 1.9%, preferably less than 1.8%, preferably less than or equal to 1.7%, and/or preferably greater than or equal to 1.4%, as molar percentages on the basis of the sum of ZrO₂, HfO₂, Y₂O₃ and CeO₂;
the content of Y₂O₃ is greater than or equal to 1.3%, preferably greater than or equal to 1.4% and less than 1.8%, preferably less than or equal to 1.7%, as molar percentages on the basis of the sum of ZrO₂, HfO₂, Y₂O₃ and CeO₂;
the content of CeO₂ is greater than or equal to 0.6%, preferably greater than or equal to 0.7%, preferably greater than or equal to 0.8%, and less than or equal to 1.7%, preferably less than or equal to 1.6%, preferably less than or equal to 1.5%, as molar percentages on the basis of the sum of ZrO₂, HfO₂, Y₂O₃ and CeO₂;
the content of Al₂O₃, as mass percentages on the basis of the oxides, is greater than or equal to 0.2% and less than or equal to 1.2%, preferably less than or equal to 0.8%, or less than 0.1%;
the content of CaO, as mass percentage on the basis of the oxides, is less than 1.0%, or greater than 0.2%;
the total content of oxides other than ZrO₂, HfO₂, Y₂O₃, CeO₂, Al₂O₃ and CaO, as mass percentages on the basis of the oxides, is less than 2%;
as mass percentage on the basis of the total amount of crystalline phases:
the content of monoclinic zirconia is less than or equal to 10%, preferably less than or equal to 8%, preferably less than or equal to 5%;
the total content of crystalline phases other than stabilized zirconia and monoclinic zirconia is less than 5%;
the amount by mass of amorphous phase, as a mass percentage relative to the mass of said bead, is substantially zero;
the stabilized zirconia is present substantially only in the form of quadratic zirconia;
the stabilized zirconia is stabilized with Y₂O₃ and with CeO₂;
the sintered bead has an average grain size of less than 2 μm, and/or has a grain size distribution having a standard deviation of less than 0.20 μm;
the sintered bead has an average grain size of less than 0.6 μm, and/or has a grain size distribution having a standard deviation of less than 0.15 μm.

These optional features above are preferred, with the exception, for the third main embodiment, of those relating to the composition of the sintered beads.

In particular, in the third main embodiment, a sintered zirconia bead according to the invention may also have one or more of the following optional and preferred features:
the content of Y₂O₃ is greater than or equal to 1.9%, preferably greater than or equal to 2% and/or preferably less than or equal to 2.4%, preferably less than or equal to 2.2%, as molar percentages on the basis of the sum of ZrO₂, HfO₂, Y₂O₃ and CeO₂;
the content of CeO₂ is greater than or equal to 0.2%, preferably greater than or equal to 0.3%, preferably greater than or equal to 0.4% and/or preferably less than 0.8%, preferably less than 0.7%, preferably less than 0.6%, as molar percentages on the basis of the sum of ZrO₂, HfO₂, Y₂O₃ and CeO₂;
the sintered bead consists of oxides for more than 98%, preferably for more than 99%, preferably for more than 99.5%, preferably for more than 99.9% of its mass;
the content of Al₂O₃, as mass percentages on the basis of the oxides, is greater than or equal to 0.2%, preferably greater than or equal to 0.25%, and preferably less than or equal to 1.2%, preferably less than or equal to 1%, preferably less than or equal to 0.8%, or less than 0.1%;
the content of CaO, as mass percentage on the basis of the oxides, is less than 1.0%, or greater than 0.2%;
the total content of oxides other than ZrO₂, HfO₂, Y₂O₃, CeO₂, Al₂O₃ and CaO, as mass percentages on the basis of the oxides, is less than 4%, preferably less than 3%, preferably less than 2%, preferably less than 1%, preferably less than 0.8%, preferably less than 0.5%.

The invention also relates to a bead powder comprising more than 90%, preferably more than 95%, preferably substantially 100%, as mass percentages, of beads according to the invention.

The invention also relates to a device chosen from a suspension, a grinder, and surface treatment apparatus, said device including a powder of beads according to the invention.

The invention also relates to a process for manufacturing sintered zirconia beads according to the invention, said process comprising the following successive steps:
a) preparation of a particle mixture having a median size of less than 2 μm and a composition suitable for obtaining, on conclusion of step g), sintered zirconia beads according to the invention,
b) optionally, drying of said particle mixture,
c) preparation of a starting feedstock from said optionally dried particle mixture,
d) forming of the starting feedstock in the form of raw beads,
e) optionally washing,
f) optionally drying,
g) sintering at a sintering temperature above 1300° C. so as to obtain sintered beads.

A manufacturing process according to the invention may also have one or more of the following optional features:
in step a), one or more starting material powders introduced into said particle mixture are ground, preferably co-milled;
in step a), the particle mixture has a median size of less than 0.5 μm and/or a ratio (D₅₀-D₁₀)/D₅₀ of less than 2;
in step a), no starting materials other than the zirconia powders at least partially stabilized with Y₂O₃, ceria and corundum are intentionally introduced into the particle mixture;
one or more of the powders of the particle mixture are replaced, at least partially, with equivalent powders which lead, in said beads, to the same constituents, in the same amounts, with the same crystallographic phases.

The optional and preferred features listed above for the sintered beads and in relation to the compositions of these beads are also optional and preferred features of the particle mixture employed in step a) for manufacturing said beads.

The invention lastly relates to the use of a bead powder according to the invention, in particular manufactured by a process according to the invention, as grinding media, more particularly for wet grinding, as wet dispersion agents, or for surface treatment.

### Definitions

A sum of oxide contents (i.e. a formula in which these contents are linked by the sign “+”) does not imply that the two oxides linked by this sign “+” are necessarily simultaneously present.
The term “particle” means an individualized solid product in a powder.
The terms “powder” and “particle mixture” are conventionally synonymous. For the sake of clarity, in the present description, the term “particle mixture” denotes the powder which is manufactured in step a) of a process according to the invention.
Conventionally, the term “sintering” refers to the consolidation of a raw particle (granular agglomerate) by heat treatment at more than 1100° C., possibly with partial or total fusion of some (but not all) of its constituents.
The “grains” of a sintered zirconia bead consist of particles of the particle mixture agglomerated by sintering. A sintered bead according to the invention thus consists of an agglomerate of grains linked by sintering. It may also include an amorphous phase.
The term “bead” means a particle having a sphericity, i.e. a ratio between its smallest Ferret diameter and its largest Ferret diameter, of greater than 0.6, irrespective of the way in which this sphericity was obtained. Preferably, the beads according to the invention have a sphericity of greater than 0.7.
The “size” of a bead refers to its smallest Ferret diameter.
The “percentiles” 10 (noted D₁₀), 50 (noted D₅₀) and 90 (noted D₉₀) of a powder or of a particle mixture refer to the particle sizes corresponding to the percentages equal to 10%, 50% and 90%, respectively, by mass, on the cumulative particle size distribution curve of the powder or of the particle mixture, respectively, said particle sizes being ranked in ascending order. According to this definition, 10% by mass of the particles in the powder or particle mixture are thus smaller than D₁₀ in size and 90% by mass of the particles are greater than or equal to D₁₀ in size. The percentiles may be determined, for example, with a laser granulometer.
The “median size” of a particle powder or particle mixture is called the 50 percentile, D₅₀. The median size thus divides the particles of the powder or particle mixture into first and second populations of equal mass, these first and second populations including only particles with a size greater than or equal to, or less than, the median size, respectively.
The “average size” of the grains in a sintered bead is the size measured by means of a “Mean Linear Intercept” method. A measurement method of this type is described in the standard ASTM E1382.
The term “sintered bead” means a solid bead obtained by sintering a raw bead.
The “other oxides” are preferably “impurities”, i.e. unavoidable oxides, necessarily introduced with the starting materials. In particular, oxides of sodium and of other alkali metals are impurities. Examples that may be mentioned include Na₂O or K₂O. However, hafnium oxide is not considered an impurity. It is considered that a total impurity content of less than 5% does not substantially modify the results obtained.
In the context of the present patent application, HfO₂ is considered not to be chemically dissociable from ZrO₂. In the chemical composition of a product including zirconia, “ZrO₂” or “ZrO₂+HfO₂” thus refers to the total content of these two oxides. According to the present invention, HfO₂ is not intentionally added to the starting feedstock. HfO₂ thus refers only to trace amounts of hafnium oxide, as this oxide is always naturally present in zirconia sources in contents generally less than 2%.
For the sake of clarity, the terms “ZrO₂” (or “ZrO₂+HfO₂”) and “Al₂O₃” are used to refer to the contents of these oxides in the composition, and “zirconia” and “corundum” to refer to crystalline phases of these oxides consisting of ZrO₂+HfO₂, and Al₂O₃, respectively. However, these oxides may also be present in other phases. The term “zirconia” conventionally includes the small amount of hafnia phase, which is indistinguishable by X-ray diffraction.
The term “stabilized zirconia” means the combination consisting of quadratic zirconia and cubic zirconia.
The term “at least partially stabilized zirconia” means partially stabilized zirconia or fully stabilized zirconia. Partially stabilized zirconia is zirconia including monoclinic zirconia, and having a monoclinic zirconia content of less than 50%, as a mass percentage on the basis of the total amount of crystalline phases, the other phases present being the quadratic phase and/or the cubic phase. CeO₂ and Y₂O₃ serve to stabilize the zirconia but may also be present outside it.
The term “powder of a compound” means a powder including more than 95% by mass of particles including more than 90% by mass of said compound. Thus, a corundum powder includes more than 95% by mass of particles including more than 90% by mass of corundum. A “quadratic zirconia powder” includes more than 95% by mass of particles including more than 90% by mass of quadratic zirconia. A “stabilized zirconia powder” includes more than 95% by mass of particles including more than 90% by mass of stabilized zirconia.
The term “precursor” of an oxide means one or more constituents that are capable of providing said oxide during a sintering step of a manufacturing process according to the invention. For example, aluminum hydroxides are precursors of alumina.
An amount of a precursor of an oxide is said to be “equivalent” to an amount of said oxide when, during sintering, it leads to said amount of said oxide.
The specific surface area is calculated via the BET (Brunauer Emmett Teller) method as described in the Journal of the American Chemical Society, 60 (1938), pages 309 to 316.
The term “absolute density” of a sintered zirconia product, in particular of a sintered bead, means the absolute density AD calculated by means of the following equation (1):

$$A D = 100 / [ ( x / 3.987 ) + ( 100 - x ) / ADz ] \qquad ( 1 )$$

where x is the alumina content, in mass percentages, and
ADz is the absolute density of the zirconia stabilized with Y₂O₃ and CeO₂, calculated by dividing the mass of the unit cell of the zirconia by the volume of said unit cell, the zirconia being considered stabilized only in the quadratic phase. The volume of the unit cell is calculated by means of the cell parameters determined by X-ray diffraction. The mass of the unit cell is equal to the sum of the mass of the elements Zr, O, Y and Ce, present in said unit cell, considering that all of the Y₂O₃ and CeO₂ stabilizes the zirconia.
The term “bulk density” of a sintered product, in particular of a sintered bead, conventionally means the ratio equal to the mass of said sintered product divided by the volume occupied by said sintered product. It may be measured by imbibition, according to the principle of Archimedes' thrust.
The term “relative density” of a sintered product, in particular of a sintered bead, means the ratio equal to the apparent density divided by the absolute density, expressed as a percentage.
Unless otherwise mentioned, all the means are arithmetic means.
Unless otherwise mentioned, all the percentages are mass percentages on the basis of the oxides.
The terms “include”, “have” and “comprise” should be interpreted in a nonlimiting manner.
All the characteristics of the beads may be measured in accordance with the protocols described for the examples.

### BRIEF DESCRIPTION OF THE FIGURES

Other features and advantages of the invention will also become apparent on reading the detailed description to follow and on examining the attached drawing, in which:

FIG. 1 is a graph representing the compositional range according to the first and second main embodiments of the present invention, and that of international patent application No. PCT/EP2021/058816, the x-axis representing the content of Y₂O₃, and the y-axis representing the content of CeO₂, as molar percentages on the basis of the sum of ZrO₂, HfO₂, Y₂O₃ and CeO₂.

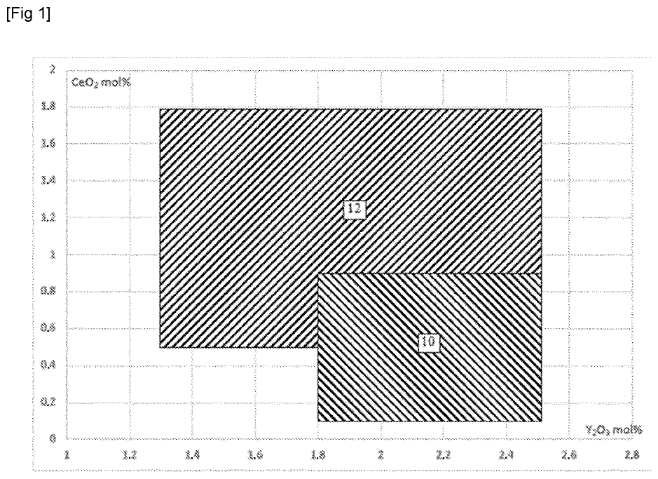

### DETAILED DESCRIPTION

### Sintered Zirconia Bead

The sintered zirconia bead according to the invention is noteworthy as regards its composition.

Surprisingly, and without being able to explain it theoretically, the inventors have discovered that the simultaneous presence of Y₂O₃ and CeO₂, in the contents present in the invention, makes it possible to achieve an excellent resistance during grinding.

A sintered zirconia bead according to the invention preferably consists of oxides for more than 98%, preferably for more than 99%, preferably for more than 99.5%, preferably for more than 99.9%, of its mass. Preferably, the sintered zirconia bead according to the invention consists substantially entirely of oxides.

Preferably, a sintered zirconia bead according to the invention has a Y₂O₃ content of greater than or equal to 1.4%, and/or preferably less than 2.4%, preferably less than 2.2%, preferably less than 2.0%, preferably less than 1.9%, preferably less than 1.8%, preferably less than or equal to 1.7%, as molar percentages on the basis of the sum of ZrO₂, HfO₂, Y₂O₃ and CeO₂.

Preferably, a sintered zirconia bead according to the invention has a Y₂O₃ content of greater than or equal to 1.3%, preferably greater than or equal to 1.4% and less than 1.8%, preferably less than or equal to 1.7%, as molar percentages on the basis of the sum of ZrO₂, HfO₂, Y₂O₃ and CeO₂.

Preferably, a sintered zirconia bead according to the invention has a CeO₂ content greater than or equal to 0.6%, preferably greater than or equal to 0.7%, preferably greater than or equal to 0.8% and/or preferably less than or equal to 1.7%, preferably less than or equal to 1.6%, preferably less than or equal to 1.5%, as molar percentages on the basis of the sum of ZrO₂, HfO₂, Y₂O₃ and CeO₂.

Preferably, a sintered zirconia bead according to the invention has a Y₂O₃ content greater than or equal to 1.4% and/or preferably less than 2.4%, preferably less than 2.2%, preferably less than 2.0%, preferably less than 1.9%, preferably less than 1.8%, preferably less than or equal to 1.7%, and a CeO₂ content of greater than or equal to 0.6%, preferably greater than or equal to 0.7%, preferably greater than or equal to 0.8% and/or preferably less than or equal to 1.7%, preferably less than or equal to 1.6%, preferably less than or equal to 1.5%, as molar percentages on the basis of the sum of ZrO₂, HfO₂, Y₂O₃ and CeO₂. Advantageously, the sintered zirconia bead has excellent resistance to wear during grinding.

In a preferred embodiment, the sintered zirconia bead according to the invention has an Al₂O₃ content of greater than or equal to 0.2%, preferably greater than or equal to 0.25% and preferably less than or equal to 1.2%, preferably less than or equal to 1%, preferably less than or equal to 0.8%, as mass percentages on the basis of the oxides.

However, tests have shown that the presence of Al₂O₃ is not essential. In one embodiment, the sintered zirconia bead according to the invention has an Al₂O₃ content of less than 0.1%, less than 0.005%, less than 0.003%, less than 0.002%, or substantially zero, as a mass percentage on the basis of the oxides.

Preferably, the sintered bead according to the invention has a CaO content of less than 1.5%, preferably less than 1.0%, as mass percentages on the basis of the oxides.

In one embodiment, the sintered zirconia bead according to the invention has a CaO content of greater than 0.1%, preferably greater than 0.2%, preferably greater than 0.3%, as a mass percentage on the basis of the oxides.

Preferably, the sintered bead according to the invention has a total content of oxides other than ZrO₂, HfO₂, Y₂O₃, CeO₂, Al₂O₃ and CaO of less than 4%, preferably less than 3%, preferably less than 2%, preferably less than 1%, preferably less than 0.8%, preferably less than 0.5%, as a mass percentage on the basis of the oxides. Preferably, in the sintered zirconia bead according to the invention, the oxides other than ZrO₂, HfO₂, Y₂O₃, CeO₂, Al₂O₃ and CaO are impurities.

Preferably, in the sintered zirconia bead according to the invention, any oxides other than ZrO₂, HfO₂, Y₂O₃, CeO₂, Al₂O₃ and CaO are present in an amount of less than 2.0%, preferably less than 1.5%, preferably less than 1.0%, preferably less than 0.8%, preferably less than 0.5%, preferably less than 0.3%.

The sintered zirconia bead according to the invention preferably has a content of monoclinic zirconia, as a mass percentage on the basis of the total amount of crystalline phases, of less than or equal to 10%, preferably less than or equal to 8%, preferably less than or equal to 5%, preferably substantially zero.

The sintered zirconia bead according to the invention preferably has a total content of crystalline phases other than stabilized zirconia and monoclinic zirconia, as a mass percentage on the basis of the total amount of crystalline phases, of less than 6%, preferably less than 5% or even less than 4%.

In the sintered zirconia bead according to the invention, the zirconia is stabilized with Y₂O₃ and CeO₂. Preferably, the stabilized zirconia is present substantially only in the form of quadratic zirconia.

Preferably, in the sintered zirconia bead according to the invention, the mass amount of amorphous, i.e. vitreous, phase as a mass percentage relative to the mass of said bead is less than 7%, preferably less than 5%, preferably substantially zero.

The sintered zirconia bead according to the invention has an average grain size of less than 2 μm, preferably less than 1.5 μm, preferably less than 1 μm, preferably less than 0.9 μm, preferably less than 0.8 μm, preferably less than 0.6 μm, preferably less than 0.5 μm, and preferably greater than 0.1 μm, preferably greater than 0.15 μm. Advantageously, the resistance during grinding is improved.

Preferably, the sintered zirconia bead according to the invention has a grain size distribution with a standard deviation of less than 0.20 μm, preferably less than 0.15 μm, preferably less than 0.1 μm.

In a preferred embodiment, the sintered zirconia bead according to the invention has:
the following chemical composition, as mass percentages on the basis of the oxides:
   ZrO₂+HfO₂+Y₂O₃+CeO₂: balance to 100%;
   0%≤ Al₂O₃≤1.5%, the Al₂O₃ content being preferably greater than or equal to 0.2%, preferably greater than or equal to 0.25% and preferably less than or equal to 1.2%, preferably less than or equal to 1%, preferably less than or equal to 0.8%;
   CaO≤2%, the CaO content being preferably less than 1.5%, preferably less than 1.0%;
   oxides other than ZrO₂, HfO₂, Y₂O₃, CeO₂, Al₂O₃ and CaO, or “other oxides”: ≤5%, the content of “other oxides” being preferably less than 4%, preferably less than 3%,
preferably less than 2%, preferably less than 1%, more preferably less than 0.8%, preferably less than 0.5%,
the contents of Y₂O₃ and CeO₂, as molar percentages on the basis of the sum of ZrO₂, HfO₂, Y₂O₃ and CeO₂, being such that the Y₂O₃ content is greater than or equal to 1.3%, preferably greater than or equal to 1.4% and less than 1.8%, preferably less than or equal to 1.7%, and such that the CeO₂ content is greater than or equal to 0.6%, preferably greater than or equal to 0.7%, preferably greater than or equal to 0.8% and less than or equal to 1.7%, preferably less than or equal to 1.6%, preferably less than or equal to 1.5%, and
the following crystalline phases, as mass percentages on the basis of the crystalline phases and for a total of 100%:
   stabilized zirconia: balance to 100%, said stabilized zirconia being stabilized with Y₂O₃ and CeO₂, and being preferably present substantially only in the form of quadratic zirconia;
   monoclinic zirconia≤15%, the content of monoclinic zirconia being preferably less than or equal to 10%, preferably less than or equal to 8%, preferably less than or equal to 5%, preferably substantially zero;
crystalline phases other than stabilized zirconia and monoclinic zirconia, or “other crystalline phases”: <7%, the content of other crystalline phases being preferably less than 5%, preferably substantially zero, and
an amount by mass of amorphous phase, as mass percentage relative to the mass of the sintered zirconia bead, of less than 7%, preferably less than 5%, preferably substantially zero.

In said preferred embodiment, the sintered zirconia bead preferably has an average grain size of less than 2 μm, preferably less than 1.5 μm, preferably less than 1 μm, preferably less than 0.9 μm, preferably less than 0.8 μm, preferably less than 0.6 μm, preferably less than 0.5 μm, and preferably greater than 0.1 μm, preferably greater than 0.15 μm.

Preferably, the sintered zirconia bead according to the invention has a relative density of greater than 99%, preferably greater than 99.5%, preferably greater than 99.6%, preferably greater than 99.7%, preferably greater than 99.8%, preferably greater than 99.9%, the absolute density being calculated according to the method described previously.

The sintered zirconia bead according to the invention preferably has a size of less than 10 mm, preferably less than 2.5 mm and/or greater than 0.005 mm, preferably greater than 0.01 mm, preferably greater than 0.02 mm, preferably greater than 0.03 mm.

A sintered zirconia bead according to the invention preferably has a sphericity of greater than 0.7, preferably greater than 0.8, preferably greater than 0.85, or even greater than 0.9.

A sintered zirconia bead according to the invention may be manufactured by means of a manufacturing process according to the invention.

### Process for Manufacturing Sintered Zirconia Beads

To manufacture sintered zirconia beads according to the invention, steps a) to g) described above and detailed below may be performed.

In step a), a particle mixture with a median size of less than 2 μm is prepared. The composition of the particle mixture is also adapted, in a manner known per se, so that the sintered zirconia beads have a composition in accordance with the invention.

The starting material powders are intimately mixed.

The starting material powders may be ground individually or preferably co-milled so that the resulting particle mixture has a median size of less than 2 μm, preferably less than 1.5 μm, preferably less than 1 μm, preferably less than 0.8 μm, preferably less than 0.6 μm, preferably less than 0.5 μm, preferably less than 0.4 μm, preferably less than 0.3 μm, and/or preferably greater than 0.05 μm. This grinding may be wet grinding. Grinding or co-milling may also be used to obtain an intimate mixture.

Preferably, the particle mixture has a ratio (D₅₀-D₁₀)/D₅₀ of less than 2, preferably less than 1.5, preferably less than 1.

Y₂O₃ and CeO₂ are known stabilizers of zirconia. In the particle mixture, they may or may not stabilize the zirconia. According to the invention, the particle mixture should, however, lead to a sintered zirconia bead according to the invention.

In the particle mixture, the zirconia is preferably, at least partially, stabilized with Y₂O₃. Preferably then, a CeO₂ ceria powder is used as the source of CeO₂. In said embodiment, the zirconia powder is at least partially stabilized with Y₂O₃ and has a specific surface area, calculated via the BET method, of greater than 0.5 m²/g, preferably greater than 1 m²/g, preferably greater than 1.5 m²/g, and/or less than 20 m²/g, preferably less than 18 m²/g, preferably less than 15 m²/g. Advantageously, the optional grinding, generally in suspension, is thereby facilitated. Furthermore, the sintering temperature in step f) may be reduced. In said embodiment, in said zirconia powder at least partially stabilized with Y₂O₃, the zirconia is substantially only in the quadratic form.

A ceria and/or yttria and/or zirconia precursor may also be used in the particle mixture.

The ceria and/or the ceria precursor and/or the yttria and/or the yttria precursor may be incorporated, partially or totally, into the particle mixture in the form of a powder, i.e. in a form separate from the zirconia, so that, after sintering, the zirconia is at least partially stabilized. In this embodiment, the median size of the yttria powder and/or of the yttria precursor and/or of the ceria powder and/or of the ceria precursor is preferably less than 1 μm, preferably less than 0.5 μm, more preferably less than 0.3 μm. The zirconia-stabilizing efficiency is thereby advantageously improved during the sintering.

In one embodiment, the particle mixture includes particles in which stabilized or nonstabilized zirconia and yttria and/or ceria are intimately mixed. Such an intimate mixture may be obtained, for example, by coprecipitation, thermal hydrolysis or atomization, and optionally consolidated by heat treatment. In a said particle mixture, yttria and/or ceria may be replaced with an equivalent amount of precursor(s).

Preferably, the particle mixture does not include any yttria precursor.

Preferably, the particle mixture does not include any ceria precursor.

Preferably, the particle mixture does not include any zirconia precursor.

Preferably, the particle mixture does not include any monoclinic zirconia powder.

Preferably, for the first and second main embodiments, and insofar as these features are compatible with these embodiments, the Y₂O₃ content is greater than or equal to 1.4%, and/or preferably less than or equal to 2.4%, preferably less than 2.2%, preferably less than 2.0%, preferably less than 1.9%, preferably less than 1.8%, preferably less than or equal to 1.7%, as molar percentages on the basis of the sum of ZrO₂, HfO₂, Y₂O₃ and CeO₂ present in said particle mixture.

Preferably, for the first and second main embodiments, and insofar as these features are compatible with these embodiments, the Y₂O₃ content is greater than or equal to 1.3%, preferably greater than or equal to 1.4% and less than 1.8%, preferably less than or equal to 1.7%, as molar percentages on the basis of the sum of ZrO₂, HfO₂, Y₂O₃ and CeO₂ present in said particle mixture.

Preferably, for the first and second main embodiments, and insofar as these features are compatible with these embodiments, the CeO₂ content is greater than or equal to 0.6%, preferably greater than or equal to 0.7%, preferably greater than or equal to 0.8% and/or preferably less than or equal to 1.7%, preferably less than or equal to 1.6%, preferably less than or equal to 1.5%, as molar percentages on the basis of the sum of ZrO₂, HfO₂, Y₂O₃ and CeO₂ present in said particle mixture.

Preferably, for the first and second main embodiments, and insofar as these features are compatible with these embodiments, the Y₂O₃ content is greater than or equal to 1.4% and/or preferably less than or equal to 2.4%, preferably less than 2.2%, preferably less than 2.0%, preferably less than 1.9%, preferably less than 1.8%, preferably less than or equal to 1.7%, and the CeO₂ content is greater than or equal to 0.6%, preferably greater than or equal to 0.7%, preferably greater than or equal to 0.8% and/or preferably less than or equal to 1.7%, preferably less than or equal to 1.6%, preferably less than or equal to 1.5%, as molar percentages on the basis of the sum of ZrO₂, HfO₂, Y₂O₃ and CeO₂ present in said particle mixture. Advantageously, the sintered zirconia bead obtained from said particle mixture has excellent resistance during grinding.

In a preferred embodiment for the first and second main embodiments, and insofar as these features are compatible with these embodiments, the Y₂O₃ content is greater than or equal to 1.3%, preferably greater than or equal to 1.4% and less than 1.8%, preferably less than or equal to 1.7%, and the CeO₂ content is greater than or equal to 0.6%, preferably greater than or equal to 0.7%, preferably greater than or equal to 0.8% and preferably less than or equal to 1.7%, preferably less than or equal to 1.6%, preferably less than or equal to 1.5%, as molar percentages on the basis of the sum of ZrO₂, HfO₂, Y₂O₃ and CeO₂ present in said particle mixture.

In a preferred embodiment, the particle mixture comprises alumina powder in an amount of greater than or equal to 0.2%, preferably greater than or equal to 0.25% and preferably less than or equal to 1.2%, preferably less than or equal to 1%, preferably less than or equal to 0.8%, as mass percentages on the basis of the mass of the particle mixture.

Advantageously, the sinterability of the particle mixture is thereby improved. The alumina may be replaced, totally or partly, with an equivalent amount of precursor. Preferably, the particle mixture does not include any alumina precursor. More preferably, the alumina is essentially present in the form of corundum, which preferably has a median size of less than μm, preferably less than 3 μm, preferably less than 1 μm.

However, tests have shown that the presence of alumina is not essential. In one embodiment, the alumina content may in particular be less than 0.1%, less than 0.05%, less than 0.03%, less than 0.01%, or substantially zero, as mass percentages on the basis of the mass of the particle mixture.

In one embodiment, the particle mixture includes powders of
zirconia at least partially stabilized with Y₂O₃,
ceria,
corundum.

The powders providing the oxides are preferably chosen so that the total content of oxides other than ZrO₂, HfO₂, Y₂O₃, CeO₂, Al₂O₃ and CaO is less than 5%, as a mass percentage on the basis of the oxides.

Preferably, no starting materials other than powders of zirconia at least partially stabilized with Y₂O₃, ceria and corundum are intentionally introduced into the particle mixture, the other oxides present being impurities.

Preferably, the powders used each have a median size of less than 5 μm, preferably less than 3 μm, preferably less than 2 μm, preferably less than 1 μm, preferably less than 0.7 μm, preferably less than 0.6 μm, preferably less than 0.5 μm, preferably less than 0.4 μm, or even less than 0.3 μm.

Irrespective of the embodiment, one or more of the powders of the particle mixture described above may be replaced, at least partially, with equivalent powders, i.e. with powders which, during the manufacture of a bead according to the invention, lead to the same constituents (same composition, same crystallographic phase) in said bead, in the same amounts.

In step b), which is optional, the particle mixture may be dried, for example in an oven or by atomization, in particular if it has been obtained by wet grinding or if at least one starting material powder has been obtained by wet grinding. Preferably, the temperature and/or duration of the drying step are adapted so that the residual moisture content of the particle mixture is less than 2%, or even less than 1.5%.

In step c), a starting feedstock is prepared, preferably at room temperature, including the particle mixture obtained at the end of step a) or at the end of step b) and, optionally, a solvent, preferably water, the amount of which is adapted to the forming method of step d).

As is well known to those skilled in the art, the starting feedstock is adapted to the forming process of step d).

In particular, the forming may result from a gelation process. To this end, a solvent, preferably water, is preferably added to the starting feedstock so as to produce a suspension.

The suspension preferably has a solids content by mass of between 50% and 70%.

The suspension may also include one or more of the following constituents:
a dispersant, in an amount of from 0 to 10%, as a mass percentage on the basis of the solids;
a surface tension modifier, in an amount of from 0 to 3%, as a mass percentage on the basis of the solids;
a gelling agent, or “gellant”, in an amount of from 0 to 2%, as a mass percentage on the basis of the solids.

Dispersants, surface tension modifiers and gelling agents are well known to those skilled in the art.

Examples that may be mentioned include:
as dispersants, the family of sodium or ammonium polymethacrylates, the family of sodium or ammonium polyacrylates, the family of citrates, for example of ammonium, the family of sodium phosphates, and the family of carbonic acid esters;
as surface tension modifiers, organic solvents such as aliphatic alcohols;
as gelling agents, natural polysaccharides.

The particle mixture is preferably added to a mixture of water and dispersants/deflocculants in a ball mill. After stirring, water in which a gelling agent has been previously dissolved is added to obtain a suspension.

If the forming is performed by extrusion, thermoplastic polymers or thermosetting polymers may be added to the starting feedstock, which preferably does not contain any solvent.

In step d), any conventional forming process known for the manufacture of sintered beads may be performed.

Among these processes, mention may be made of:
granulation processes, for example using granulators, fluidized-bed granulators or granulation disks,
gelling processes,
injection molding or extrusion processes, and
pressing processes.

In a gelling process, drops of the suspension described above are obtained by flowing the suspension through a calibrated orifice. The drops exiting the orifice fall into a bath of a gelling solution (electrolyte adapted to react with the gelling agent) where they harden after recovering a substantially spherical shape.

In step e), which is optional, the raw beads obtained in the previous step are washed, for example with water.

In step f), which is optional, the optionally washed raw beads are dried, for example in an oven.

In step g), the optionally washed and/or dried raw beads are sintered. Preferably, the sintering is performed in air, preferably in an electric furnace, preferably at atmospheric pressure.

The sintering in step g) is performed at a temperature preferably above 1330° C., preferably above 1350° C. and preferably below 1600° C., preferably below 1550° C., preferably below 1500° C., preferably below 1450° C.

The holding time at the temperature-steady stage is preferably more than 1 hour and/or preferably less than 10 hours, preferably less than 7 hours, preferably less than 5 hours, preferably less than 3 hours. Preferably, the sintering time is between 1 and 3 hours.

The sintered zirconia beads obtained preferably have a smallest diameter of greater than 0.005 mm, preferably greater than 0.1 mm, preferably greater than 0.15 mm and less than 10 mm, preferably less than 5 mm, preferably less than 2.5 mm.

The sintered zirconia beads according to the invention are particularly well suited as agents for grinding, notably for wet grinding, or as agents for wet dispersion. The invention thus also relates to the use of a powder of beads according to the invention, or of beads manufactured according to a process according to the invention, as agents for grinding, notably for wet grinding, or as agents for wet dispersion.

The properties of the sintered zirconia beads according to the invention, and also their ease of production, make them suitable for other applications, notably for the treatment of surfaces (in particular by spraying the sintered beads according to the invention).

The invention thus also relates to a device chosen from a suspension, a grinder and surface treatment apparatus, said device including a powder of beads according to the invention.

### EXAMPLES

### Measurement Protocols

The following methods may be used to determine properties of sintered beads or mixtures of sintered beads, in particular according to the invention.

To determine the sphericity of a bead, the smallest and largest Ferret diameters are measured on a Camsizer XT machine sold by the company Horiba.

The quantification of the crystalline phases present in the sintered beads is performed directly on the beads, said beads being bonded to a self-adhesive carbon pellet, so that the surface of said pellet is covered with a maximum amount of beads.

The crystalline phases present in the sintered beads are measured by X-ray diffraction, for example using an X'Pert PRO diffractometer machine from the company Panalytical, equipped with a copper XD tube. The diffraction pattern is acquired using this equipment, over an angular range 2θ of between 5° and 100°, with a step size of 0.017°, and a counting time of 150 s/step. The front optics include a fixed used ¼° programmable divergence slit, Soller slits of 0.04 rad, a mask equal to 10 mm and a fixed anti-scattering slit of ½°. The sample is rotated on itself so as to limit preferential orientations. The rear optics include a fixed used ¼° programmable anti-scattering slit, a 0.04 rad Soller slit and an Ni filter.

The diffraction patterns are then analyzed qualitatively using the EVA software and the ICDD2016 database.

Once the phases present are highlighted, the diffraction patterns are analyzed quantitatively with the High Score Plus software by Rietveld refinement according to the following strategy:
A refinement of the background signal is performed using the “treatment” function, “determine background” with the following choices: the “bending factor” is 0 and the “granularity” is 40;
Conventionally, the ICDD sheets of the highlighted and quantifiable phases present are selected, and thus taken into account in the refinement;
An automatic refinement is then performed by selecting the background signal determined previously “use available background” and by selecting the mode “automatic: option phase fit-default Rietveld”;
A manual refinement of the “B overall” parameter of all the selected phases is then performed simultaneously;
Finally, a simultaneous manual refinement of the Caglioti W parameter of the quadratic zirconia and cubic zirconia phases is performed if the automatic function did not perform it. In this case, “W” is selected for said zirconia phases and the refinement is performed again. The results are only retained if the “Goodness of fit” parameter of the second refinement is lower than that of the first refinement.

The amount of amorphous phase present in the sintered beads is measured by X-ray diffraction, for example using an X'Pert PRO diffractometer from the company Panalytical equipped with a copper XD tube. The diffraction pattern is acquired using this equipment, in the same way as for the determination of the crystalline phases present in the beads, the analyzed sample being in the form of a powder. The method applied consists in adding a known amount of a totally crystalline standard, in this case a zinc oxide ZnO powder, in an amount equal to 20%, based on the mass of zinc oxide and the sample of ground sintered beads. The maximum size of the zinc oxide powder is 1 μm and the sintered beads are ground so as to obtain a maximum powder size of less than 40 μm.

The maximum ZnO particle size is entered in the High Score Plus software so as to limit the microabsorption effects.

The content of amorphous phase, as a percentage, is calculated using the following formula, where Q_{ZnO} is the amount of ZnO determined from the diffraction pattern:

Content of amorphous phase=100*(100/(100−20))*(1−(20/Q_{ZnO})).

For example, if Q_{ZnO} is equal to 22%, then the content of amorphous phase is equal to 100*(100/(100−20))*(1−(20/22))=11.4%.

The bulk density of the sintered beads is measured by hydrostatic weighing.

The unit cell parameters required for calculating the absolute density of the at least partially stabilized zirconia are determined by X-ray diffraction on the surface of the sample to be characterized (the sample not being ground into a powder) using a Brüker D8 Endeavor machine. The parameters required for the acquisition of the diffraction pattern are identical to those used for the acquisition of the diffraction pattern required for the quantification of the crystalline phases.

The unit cell parameters a and c are determined after performing a refinement of the diffraction pattern using the Fullprof software available at https://www.ill.eu/sites/fullprof/, using a pseudo-Voigt profile (with npr=5), the refined parameters being as follows:
the sample displacement using the “SyCos” function,
the Lorentzian/Gaussian proportion of the pseudo-Voigt function using the “Shape 1” function,
the width parameters at half height U, V, W,
the skewness parameters using the “Asy1” and “Asy2” functions,
the baseline points,
the space group of the partially substituted quadratic zirconia unit cell being P 42/n m c (137), considered identical to that of the unsubstituted quadratic zirconia unit cell.

The chemical analysis of the sintered beads is measured by Inductively Coupled Plasma (ICP) spectrometry for the elements whose content does not exceed 0.5%. To determine the content of the other elements, a drop of the sintered bead material to be analyzed is made by melting said material and chemical analysis is then performed by X-ray fluorescence.

The average grain size of the sintered beads is measured via the “Mean Linear Intercept” method. A method of this type is described in the standard ASTM E1382. According to this standard, analysis lines are drawn on images of the sintered beads and then, along each analysis line, the lengths, known as “intercepts”, between two consecutive grain boundaries intersecting said analysis line are measured.

The mean length “l” of the intercepts “I” is then determined.

The intercepts are measured on images obtained by scanning electron microscopy of sintered bead samples, said sections having been polished beforehand to mirror quality and then thermally etched, at a temperature 50° C. below the sintering temperature, to reveal the grain boundaries. The magnification used to take the images is chosen so as to visualize approximately 100 grains in one image. Five images per sintered bead are taken.

The average grain size “d” of a sintered bead is given by the relationship: d=1.56×l′. This formula is taken from formula (13) of the article “Average Grain Size in Polycrystalline Ceramics” M. I. Mendelson, J. Am. Ceram. Soc. Vol. 52, No. 8, pages 443-446.

The standard deviation of the grain size distribution is 1.56 times the standard deviation of the intercept distribution “I”.

The specific surface area of a powder or particle mixture is measured via the BET (Brunauer Emmett Teller) method described in the Journal of the American Chemical Society, 60 (1938), pages 309 to 316.

The 10, 50 and 90 percentiles of the powders and particle mixtures are conventionally measured using an LA950V2 model laser granulometer sold by the company Horiba.

To determine the “planetary wear”, 20 ml (volume measured using a graduated cylinder) of test beads with a size of between 0.9 and 1.1 mm are weighed out (mass m0) and introduced into one of the four bowls lined with dense sintered alumina, having a capacity of 125 ml, of a Retsch brand PM400 fast planetary mill. 2.2 g of Presi silicon carbide (with a median size D₅₀ of 23 μm) and 40 ml of water are added to the same bowl already containing the beads. The bowl is closed and rotated (planetary motion) at 400 rpm with the direction of rotation reversed every minute for 1.5 hours. The contents of the bowl are then washed over a 100 μm sieve so as to remove the residual silicon carbide and any material removed by wear during the grinding. After screening on a 100 μm sieve, the beads are dried in an oven at 100° C. for 3 hours and then weighed (mass m1). Said beads (mass m1) are again introduced into one of the bowls with a suspension of SiC (same concentration and amount as before) and undergo a new grinding cycle, identical to the previous one. The contents of the bowl are then washed over a 100 μm sieve so as to remove the residual silicon carbide and any material removed by wear during the grinding. After screening on a 100 μm sieve, the beads are dried in an oven at 100° C. for 3 hours and then weighed (mass m2). Said beads (mass m2) are again introduced into one of the bowls with a suspension of SiC (same concentration and amount as before) and undergo a new grinding cycle, identical to the previous one. The contents of the bowl are then washed over a 100 μm sieve so as to remove the residual silicon carbide and any material removed by wear during the grinding. After screening on a 100 μm sieve, the beads are dried in an oven at 100° C. for 3 hours and then weighed (mass m3).

The planetary wear (PW) is expressed as a percentage (%) and is equal to the loss of mass of the beads relative to the initial mass of the beads, i.e.: 100(m2−m3)/(m2); the PW result is given in Table 2.

### Manufacturing Protocol

Sintered beads were prepared using:
an yttriated zirconia powder containing a molar Y₂O₃ content of 2.5%, having a specific surface area of the order of 10 m²/g and a median size of less than 0.3 μm for example 1,
an yttriated zirconia powder containing a molar Y₂O₃ content of 3%, having a specific surface area of the order of 10 m²/g and a median size of less than 0.3 μm for example 2,
an yttriated zirconia powder containing a molar Y₂O₃ content of 2%, having a specific surface area of the order of 10 m²/g and a median size of less than 0.3 μm for examples 3 to 5,
an yttriated zirconia powder containing a molar Y₂O₃ content of 1%, having a specific surface area of the order of 10 m²/g and a median size of less than 0.3 μm for examples 3 to 5,
a CeO₂ ceria powder with a purity greater than 99%, having a median size of less than 10 μm for examples 3 to 5,
an alumina powder with a purity greater than 99%, having a median size of less than 0.5 μm for examples 1 to 5.

Table 1 below summarizes the particle mixtures of the examples obtained in step a).

TABLE 1

| | | | | | |
|---|---|---|---|---|---|
| Examples | 1(*) | 2(*) | 3 | 4 | 5 |

Composition of the particle mixture (in mass percentages)

| | | | | | |
|---|---|---|---|---|---|
| Zirconia powder with | — | 99.4 | — | — | 40.9 |
| 3 mol % of Y₂O₃ | | | | | |
| Zirconia powder with | — | — | 61.56 | 62.10 | 56.2 |
| 2 mol % of Y₂O₃ | | | | | |
| Zirconia powder with | 99.1 | — | — | — | — |
| 2.5 mol % of Y₂O₃ | | | | | |
| Zirconia powder with | — | — | 35.74 | 36.05 | — |
| 1 mol % of Y₂O₃ | | | | | |
| Ceria powder | — | — | 2.1 | 1.25 | 2.3 |
| Alumina powder | 0.9 | 0.6 | 0.6 | 0.6 | 0.6 |

(*): outside the invention

In step a), the various powders were mixed and then co-milled wet until a particle mixture with a median size of less than 0.3 μm was obtained.

In step b), the particle mixture was then dried.

In step c), for each example, a starting feedstock consisting of an aqueous suspension including, as mass percentages on the basis of the solids, 1% of a carboxylic acid ester dispersant, 3% of a carboxylic acid dispersant and 0.4% of a gelling agent, namely a polysaccharide of the alginate family, was then prepared from the dry particle mixture obtained on conclusion of step b). A ball mill was used for this preparation so as to obtain good homogeneity of the starting feedstock: A solution containing the gelling agent was first formed. The particle mixture and the dispersants were successively added to water. The solution containing the gelling agent was then added. The mixture thus obtained was stirred for 8 hours. The particle size was checked using an LA950V2 model laser granulometer sold by the company Horiba (median size <0.3 μm), then water was added in a determined amount to obtain an aqueous suspension with a solids content of 68% and a viscosity, measured using a Brookfield viscometer with the LV3 spindle at a speed equal to 20 rpm, of less than 5000 centipoises. The pH of the suspension was then about 9 after optional adjustment with a strong base.

In step d), the suspension was forced through a calibrated hole and at a flow rate to obtain, after sintering, beads about 1 mm in size for these examples. The drops of suspension fell into a gelling bath based on an electrolyte (divalent cation salt), reacting with the gelling agent.

The raw beads were collected, washed with water in step e), and then dried at 80° C. in step f) to remove the moisture.

In step g), the beads were then transferred into a sintering furnace where they were sintered in the following cycle:
heating at 100° C./hour up to 500° C.,
maintenance for 2 hours at 500° C.,
heating at 100° C./hour up to 1425° C.,
maintenance for 2 hours at 1425° C.,
temperature reduction by natural cooling.

### Results

The results obtained are collated in table 2 below.

TABLE 2

| | | | | | |
|---|---|---|---|---|---|
| Examples | 1(*) | 2(*) | 3 | 4 | 5 |

Chemical analysis, as mass percentages based on the oxides

| | | | | | |
|---|---|---|---|---|---|
| ZrO₂ + HfO₂ | 94.3 | 93.6 | 94.23 | 94.88 | 92.96 |
| Y₂O₃ | 4.4 | 5.4 | 2.77 | 2.87 | 4 |
| CeO₂ | 0 | 0 | 1.96 | 1.22 | 2 |
| Al₂O₃ | 0.9 | 0.6 | 0.6 | 0.57 | 0.61 |
| CaO | 0.3 | 0.3 | 0.34 | 0.36 | 0.33 |
| Other oxides | 0.1 | 0.1 | 0.1 | 0.1 | 0.1 |

Chemical analysis as molar percentages
based on ZrO₂ + HfO₂ + Y₂O₃ + CeO₂

| | | | | | |
|---|---|---|---|---|---|
| Y₂O₃ | 2.5 | 3 | 1.55 | 1.6 | 2.25 |
| CeO₂ | 0 | 0 | 1.44 | 0.9 | 1.48 |

Crystalline phases, as mass percentages based on
the crystalline phases and for a total of 100%

| Stabilized zirconia | Balance to 100% | | | | |
|---|---|---|---|---|---|
| Monoclinic zirconia | <5 | <5 | <5 | 11 | <5 |
| Other crystalline phases | — | — | — | — | — |

Other characteristics of the sintered beads

| | | | | | |
|---|---|---|---|---|---|
| Apparent density (g/cm³) | 6.04 | 6.04 | 6.08 | 6.08 | 6.04 |
| Average grain size (μm) | 0.29 | 0.2 | 0.19 | 0.22 | 0.27 |
| Planetary wear PW (in %) | 1.6 | 1.7 | 1.5 | 1.4 | 1.5 |

(*): outside the invention

The sintered beads of the examples consist substantially entirely of oxides and have an amount of amorphous phase of less than 5% by mass.

The bead powders in the examples have an average sphericity of greater than 0.9.

Example 2, outside the invention, is representative of the prior art and is given as a basis for comparison with example 3 according to the invention, the total molar Y₂O₃+CeO₂ content of these two examples being substantially identical.

Example 1, outside the invention, is given as a basis for comparison with example 4 according to the invention, the total molar Y₂O₃+CeO₂ content of these two examples being substantially identical.

A comparison of example 2, outside the invention, and example 3, according to the invention, shows that the beads according to example 3 exhibit 11.8% less planetary wear PW than example 2.

A comparison of example 1, outside the invention, and example 4, according to the invention, shows that the beads according to example 4 exhibit 12.5% less planetary wear PW than example 1.

A comparison of example 2, outside the invention, and example 5, according to the invention, shows that the beads according to example 5 exhibit 11.8% less planetary wear PW than example 2, these examples having molar contents of Y₂O₃+CeO₂, on the basis of the molar content of ZrO₂+HfO₂+Y₂O₃+CeO₂, of 3% and 3.73%, respectively.

As is clearly apparent at present, the invention provides a sintered zirconia bead which exhibits a notable planetary wear PW.

It will be appreciated that the invention, however, is not limited solely to the embodiments described above.

1. A sintered bead having
a chemical composition, as mass percentages on the basis of the oxides, comprising:
ZrO₂+HfO₂+Y₂O₃+CeO₂: balance to 100%;
0%≤Al₂O₃≤1.5%;
CaO≤2%;
oxides other than ZrO₂, HfO₂, Y₂O₃, CeO₂, Al₂O₃ and CaO: ≤5%;
the contents of Y₂O₃ and CeO₂, as molar percentages on the basis of the sum of ZrO₂, HfO₂, Y₂O₃ and CeO₂, being such that
1.3%≤Y₂O₃≤2.5%, and
0.1%≤CeO₂≤1.7%, and
the following crystalline phases, as mass percentages on the basis of the crystalline phases and for a total of 100%:
stabilized zirconia: balance to 100%;
monoclinic zirconia: ≤15%;
crystalline phases other than stabilized zirconia and monoclinic zirconia: <7%,
with the proviso that:
Y₂O₃<1.8% with the proviso that 0.5%≤CeO₂, and/or
0.9%<CeO₂≤1.7%, and/or
10%<monoclinic zirconia ≤15%.

2. The sintered bead as claimed in claim 1, wherein the Y₂O₃ content is less than or equal to 2.2%, as molar percentages on the basis of the sum of ZrO₂, HfO₂, Y₂O₃ and CeO₂.

3. The sintered bead as claimed in claim 2, wherein the Y₂O₃ content is less than 1.8%, as molar percentages on the basis of the sum of ZrO₂, HfO₂, Y₂O₃ and CeO₂.

4. The sintered bead as claimed in claim 1, including oxides for more than 99% of its mass and/or wherein:
the Y₂O₃ content is greater than or equal to 1.4% and less than or equal to 1.7%, as molar percentages on the basis of the sum of ZrO₂, HfO₂, Y₂O₃ and CeO₂, and/or
the CeO₂ content is greater than or equal to 0.6% and less than or equal to 1.6%, as molar percentages on the basis of the sum of ZrO₂, HfO₂, Y₂O₃ and CeO₂, and/or
the Al₂O₃ content, as mass percentages on the basis of the oxides, is greater than or equal to 0.2% and less than or equal to 1.2%, and/or
the CaO content, as mass percentage on the basis of the oxides, is less than 1.0%, or greater than 0.2%, and/or
the total content of oxides other than ZrO₂, HfO₂, Y₂O₃, CeO₂, Al₂O₃ and CaO, as mass percentages on the basis of the oxides, is less than 2%.

5. The sintered bead as claimed in claim 4, wherein:
the CeO₂ content is greater than or equal to 0.8% and less than or equal to 1.5%, as molar percentages on the basis of the sum of ZrO₂, HfO₂, Y₂O₃ and CeO₂, and/or
the Al₂O₃ content, as mass percentages on the basis of the oxides, is less than or equal to 0.8%.

6. The sintered bead as claimed in claim 1, wherein, as mass percentage on the basis of the total amount of crystalline phases:
the content of monoclinic zirconia is less than or equal to 10%, and/or
the total content of crystalline phases other than stabilized zirconia and monoclinic zirconia is less than 5%.

7. The sintered bead as claimed in claim 1, wherein the amount by mass of amorphous phase, as mass percentage relative to the mass of said bead, is substantially zero.

8. The sintered bead as claimed in claim 1, wherein the stabilized zirconia is present substantially only in the form of quadratic zirconia and/or wherein the stabilized zirconia is stabilized with Y₂O₃ and with CeO₂.

9. The sintered bead as claimed in claim 1, having an average grain size of less than 2 μm, and/or having a grain size distribution which has a standard deviation of less than 0.20 μm.

10. The sintered bead as claimed in claim 9, having an average grain size of less than 0.6 μm, and/or having a grain size distribution which has a standard deviation of less than 0.15 μm.

11. A powder comprising more than 90% of beads as claimed in claim 1, as mass percentages.

12. A device chosen from a suspension, a grinder, and surface treatment apparatus, said device including a powder of beads as claimed in claim 11.

13. A process for manufacturing sintered beads as claimed in any claim 1, comprising the following successive steps:
a) preparation of a particle mixture having a median size of less than 2 μm and a composition suitable for obtaining, on conclusion of step g), said sintered beads,
b) optionally, drying of said particle mixture,
c) preparation of a starting feedstock from said optionally dried particle mixture,
d) forming of the starting feedstock in the form of raw beads,
e) optionally washing,
f) optionally drying,
g) sintering at a sintering temperature above 1300° C. so as to obtain sintered beads.

14. The manufacturing process as claimed in claim 13, in which, in step a), one or more starting material powders introduced into said particle mixture are co-milled.

15. The manufacturing process as claimed in claim 14, in which, in step a), the particle mixture has a median size of less than 0.5 μm and/or a ratio (D₉₀−D₁₀)/D₅₀ of less than 2.

16. The manufacturing process as claimed in claim 14, in which, in step a), no starting materials other than the zirconia powders at least partially stabilized with Y₂O₃, ceria and corundum are intentionally introduced into the particle mixture.

17. The manufacturing process as claimed in claim 14, in which one or more of the powders of the particle mixture are replaced, at least partially, with equivalent powders which lead, in said beads, to the same constituents, in the same quantities, with the same crystallographic phases.
